(19) United States
(12) Patent Application Publication
(10) Pub. No.: US 2026/0005477 A1
(43) Pub. Date: Jan. 1, 2026

(54) TERMINAL ASSEMBLY FOR ETHERNET CONNECTOR

(71) Applicants: APTIV CONNECTION SYSTEMS (NANTONG) LTD., Nantong (CH); APTIV ELECTRICAL CENTERS (SHANGHAI) CO. LTD., Shanghai (CN)

(72) Inventors: Mei YE, Shanghai (CN); Haifei GUAN, Shanghai (CN); Haodong SHI, Shanghai (CN)

(21) Appl. No.: 19/243,098

(22) Filed: Jun. 19, 2025

(30) Foreign Application Priority Data
Jun. 28, 2024 (CN) 202410870096.0

(51) Int. Cl. H01R 13/6597; H01R 13/506; H01R 13/6581

(52) U.S. Cl. CPC H01R 13/6597; H01R 13/506; H01R 13/6581; H01R 2201/26

(57) ABSTRACT

A male terminal assembly includes a plastic shell having a cavity configured to accommodate and position a pair of male terminals. A shielding shell is disposed at the front end of the plastic shell. The male terminal assembly is designed for connection with an unshielded twisted-pair cable, providing structural support and shielding at the interface. This male terminal assembly may be suitable for use in an Ethernet connection.

### CROSS-REFERENCE TO RELATED APPLICATION

This disclosure claims the benefit of and priority to Chinese Patent Application No. 202410870096.0, titled “Terminal Assembly for Ethernet Connector”, filed Jun. 28, 2024, the contents of which are incorporated by reference herein.

### TECHNICAL FIELD OF THE INVENTION

This disclosure relates to electrical connection technology, and in particular, relates to an Ethernet connector.

### BACKGROUND

At present, shielded twisted pair data connectors are developed and used in 10 Gbps data transmission applications. However, unshielded wiring harnesses may still be used in data transmission applications with lower transmission rates (such as 100 Mbps) to reduce costs.

Some automotive modular Ethernet connectors use a collector or shell to accommodate one or more modular terminal assembly for a single pair of twisted conductors. At the end of this single pair of twisted conductors, insulation outer jacket is stripped to expose a pair of conductors that are twisted together, and a terminal assembly is attached to this twisted pair. Then, the terminal assembly is installed into a terminal channel of a collector or housing.

Most of the terminal assemblies used in the above-mentioned automotive modular Ethernet connectors are shielded connectors that are compatible with shielded twisted pair (STP) cable. In some in-vehicle network applications, transmission rates of 100 Mbps or 1 Gbps may be met using unshielded twisted-pair (UTP) cable. However, due to the lack of connectors suitable for use with STP, the industry uses STP connectors for relatively low-speed transmission as well, and in sequence, STP cable is used in manufacturing the relevant harness product, resulting in undesirably high cost for wiring harness products.

### SUMMARY

The present disclosure presents a terminal assembly which is configured to be connected with UTP cables and has a shielding shell at its front to provide a mating interface identical to or similar to an STP connector. An Ethernet connector containing such a terminal assembly may be connected with a mating connector originally developed to match an STP connector.

According to one aspect of this disclosure, a male terminal assembly is proposed, this male terminal assembly includes a plastic shell. The plastic shell has a cavity configured to accommodate and position a pair of male terminals. A shielding shell is disposed at the front end of the plastic shell. The male terminal assembly is configured to connect with an unshielded twisted-pair cable.

In the above-mentioned solution of male terminal assembly, optionally, the male terminal assembly is configured to be suitable for installation into a housing of electrical connector for twisted-pair cable, the housing of electrical connector for twisted-pair cable has terminal channel for receiving one or more terminal assembles.

In the above-mentioned solution of male terminal assembly, optionally, wherein the housing of electrical connector for twisted-pair cable is a housing of electrical connector for shielded twisted-pair (STP) cable.

In the above-mentioned solution of male terminal assembly, optionally, the male terminal assembly is detachably mounted to the front end of the plastic shell.

In the above-mentioned solution of male terminal assembly, optionally, the male terminal assembly is configured to be installed into a housing of electrical connector for unshielded twisted-pair (UTP) cable after the shielding shell is removed.

In the above-mentioned solution of male terminal assembly, optionally, wherein the male terminal assembly includes a main body and a mating part, the main body is within the plastic shell, and the mating part is extending beyond the front of the plastic shell.

In the above-mentioned solution of male terminal assembly, optionally, wherein the shielding shell is circumferentially surrounding the mating part.

In the above-mentioned solution of male terminal assembly, optionally, wherein the rear part of the shielding shell is sleeved on the plastic shell, and the front part of the shielding shell is extending beyond the mating part.

In the above-mentioned solution of male terminal assembly, optionally, the plastic shell is assembled from an upper shell and a lower shell.

In the above-mentioned solution of male terminal assembly, optionally, the unshielded twisted-pair cable includes a single twisted-pair of conductors, and an insulation sheath covering the single twisted-pair of conductors.

In the above-mentioned solution of male terminal assembly, optionally, the rear part of the plastic shell includes a cable retaining portion to accommodate and retain a segment of unshielded twisted-pair cable with the insulation sheath not being stripped away.

In the above-mentioned solution of male terminal assembly, optionally, the male terminal assembly is not configured to connect with a shielded twisted-pair cable.

According to one aspect of this disclosure, an Ethernet connector is proposed, the Ethernet connector including: a collector, the collector having a terminal channel to receive terminal assembly; one or more male terminal assemblies mentioned above, to be inserted into the terminal channel of the collector.

In the above-mentioned solution of Ethernet connector, optionally, the Ethernet connector is modular Ethernet connector for automobile vehicle.

In the above-mentioned solution of Ethernet connector, optionally, the Ethernet connector is configured to connect with an unshielded twisted-pair cable.

### Technical Merit

The male terminal assembly proposed in this disclosure may be connected to unshielded twisted pair cable and thus may form a UTP connector. The front of the male terminal assembly has a shielding shell, so the UTP connector formed by it may provide the same or similar mating interface as a STP connector. A male connector including such type of male terminal component may be applied to unshielded twisted-pair cable, meanwhile the female connector that matches the male connector may still use connector developed for STP applications.

### BRIEF DESCRIPTION OF THE DRAWINGS

In order to provide a clearer explanation of the embodiments of the present disclosure, a brief introduction will be given to the drawings to be used for depicting the embodiments. It is obvious that the drawings described below are only some embodiments of the present disclosure.

FIG. 1 shows an isometric view of the structure of a terminal assembly for an Ethernet connector according to some embodiments.

FIG. 2 shows an exploded view of the terminal assembly according to some embodiments.

FIG. 3 shows an exploded view of the terminal assembly according to some embodiments.

FIG. 4 shows an end view of mating end of the terminal assembly according to some embodiments.

FIG. 5 shows a cross-sectional view of the terminal assembly taken along line A-A in FIG. 4 according to some embodiments.

FIG. 6 shows an isometric view of the collector used in conjunction with the terminal assembly according to some embodiments.

### DETAILED DESCRIPTION

The following will provide a clear and complete description of the technical solution in the embodiments of the present disclosure, in conjunction with the accompanying drawings. Obviously, the described embodiments are only a part of the embodiments of the present disclosure, not all of them. Based on the embodiments in this disclosure, all other embodiments obtained by those skilled in the art without any creative effort are within the scope of protection of this disclosure.

In the description of this disclosure, it should be understood that the terms “thickness”, “up”, “down”, “top”, “bottom”, “inside”, “outside”, etc. indicate orientation or positional relationships based on the orientation or positional relationships shown in the accompanying drawings, only for the convenience of describing this disclosure and simplifying the description, and do not indicate or imply that the device or element referred to must have a specific orientation, be constructed and operated in a specific orientation, and therefore cannot be understood as a limitation of this disclosure. In addition, the terms “first” and “second” are only used for descriptive purposes and cannot be understood as indicating or implying relative importance or implying the number of technical features indicated. Thus, the features limited to “first” and “second” may explicitly or implicitly include one or more features. In the description of this disclosure, “multiple” means two or more, and at least one refers to one, two, or more, unless otherwise specifically limited.

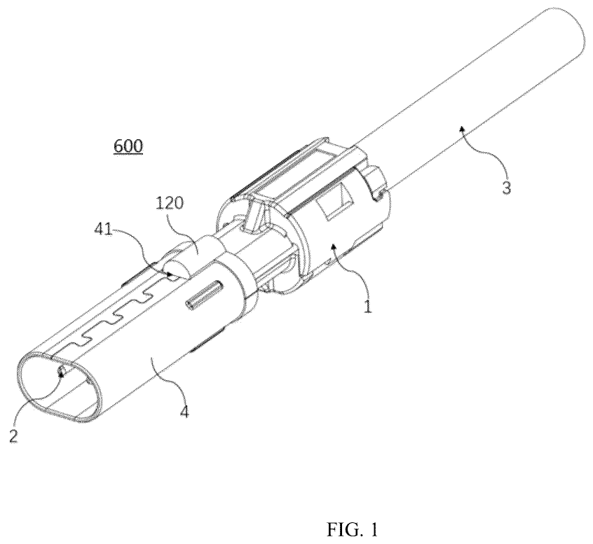

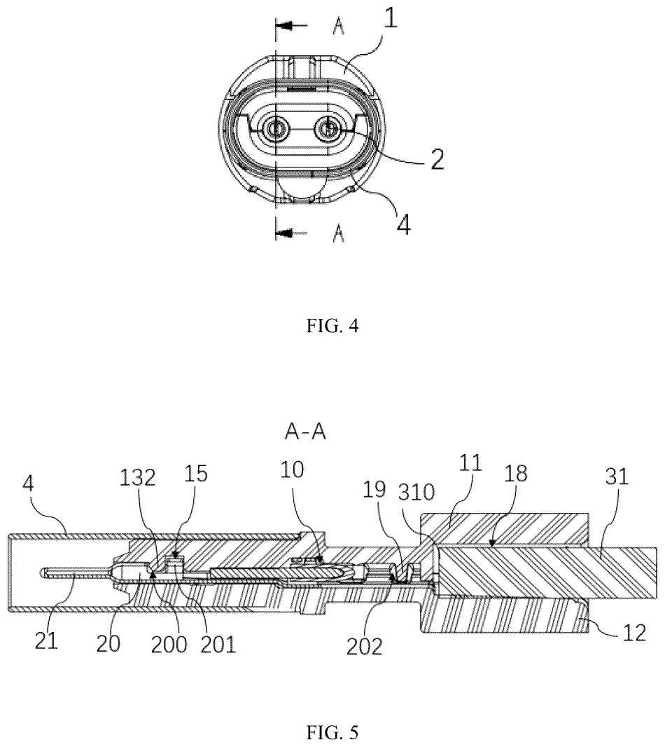

The embodiments as shown in FIGS. 1-6 provide a male end Ethernet connector for an unshielded twisted-pair (UTP) cable.

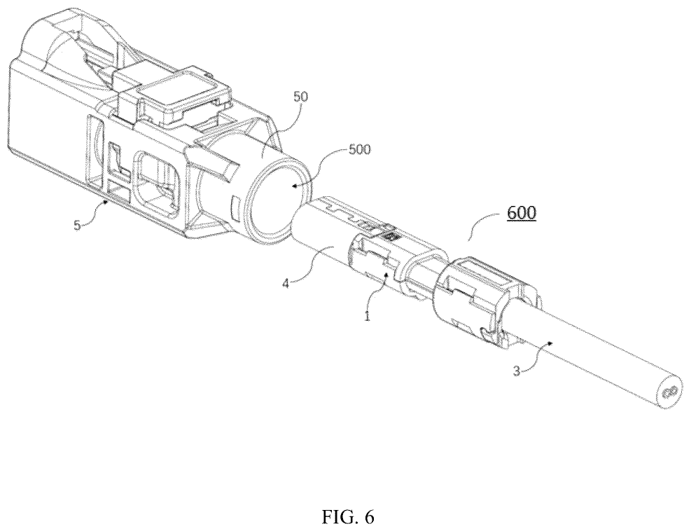

Referring to FIG. 6, the male Ethernet connector includes a shell 5 and a terminal assembly 600 configured to be installed into in the housing 5. Specifically, the terminal assembly 600 is configured to be insertable from the rear end 50 of the shell 5 and positioned in the terminal channel 500. In some scenarios, the housing 5 may be referred to as a collector, which is designed to accommodate one or more terminal assemblies as needed. In certain situations, terminal assembly 600 is also referred to as a terminal insert.

Further details of terminal assembly 600 will be described with reference to FIGS. 1-5.

Referring to FIG. 1, the terminal assembly 600 includes a plastic shell 1 and a shielding shell 4 mounted at the front end of the plastic shell 1. A twisted-pair cable 3 includes a twisted pair of conductors 30 and an insulation sheath 31 covering the twisted pair of conductors 30. This twisted-pair cable 3 is to be installed into the rear of the terminal assembly 600.

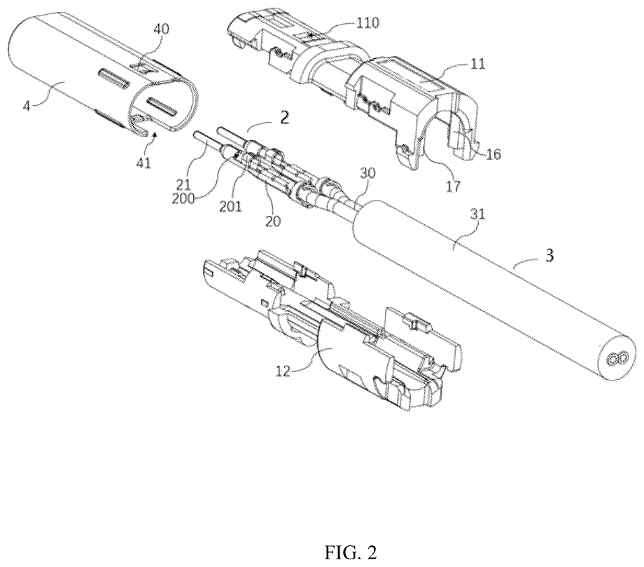

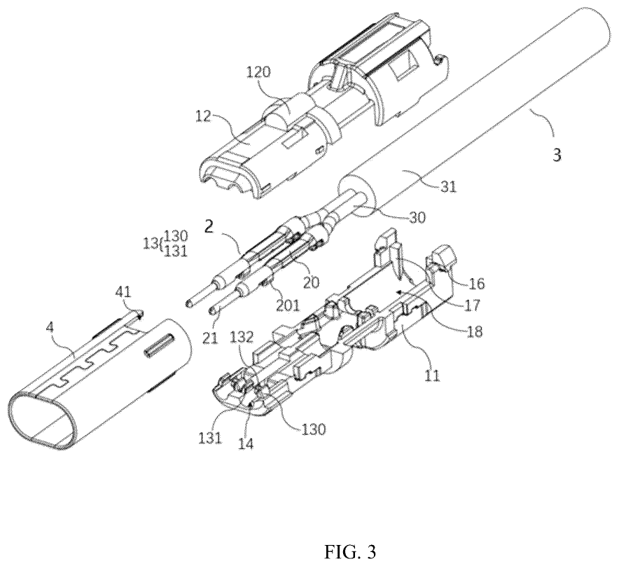

As shown in the exploded views of FIGS. 2 and 3, the plastic shell 1 of the terminal assembly 600 is a two-part design, including an upper shell 11 and a lower shell 12, that may be assembled together. At multiple locations on the upper shell 11 and lower shell 12, interlocking mechanisms, such as latching structures, are arranged, thereby providing a stable connection relationship when the two are joined together as a whole as shown in FIG. 1. It may be appreciated that the names of the upper shell and the lower shell are only used to distinguish their spatial relationship. The names of the two shells may be interchanged, that is, according to the industry practice that may change over time, the manufacturer's definition, or the customer's definition, the upper shell 11 shown in FIGS. 2 and 3 may also be called the lower shell, and the lower shell 12 shown in FIGS. 2 and 3 may also be called the upper shell. Alternatively, the upper shell 11 may be referred to as a first half shell, and the lower shell 12 may be referred to as a second half shell.

As shown in FIG. 5, the plastic shell 1 obtained by assembling the upper shell 11 and the lower shell 12 together has an accommodating cavity 10. The accommodating cavity 10 is used to accommodate and position a pair of male terminals 2. At the rear (tail) of the plastic shell 1, there is a cable retaining part that is in communication with the accommodating cavity 10 but having a larger space. The cable retaining part is used to accommodate a twisted-pair cable 3 without insulation sheath 31 being stripped away. The middle part of the plastic shell 1 may be set thinner than the front part and the rear part, thereby forming a waist-like structure.

Referring to FIGS. 2, 3, and 5, the male terminal 2 installed in the accommodating cavity 10 may be made of metallic material and includes a main body 20 and a mating part 21 that are interconnected. The main body 20 is located in the accommodating cavity 10, and the mating part 21 extends out of the accommodating cavity 10 to connect with a matching female terminal (not shown). Referring further to FIG. 5, the shielding shell 4 is mounted onto the front end of the plastic shell 1, and the front end of the shielding shell 4 extends beyond the front end of the plastic shell 1, so that the mating part 21 is located in a space enclosed by the shielding shell 4.

The shielding shell 4 is a component with good electrical conductivity, for example, it may be made of metal such as iron. Due to the shielding shell 4 being configured to surround the mating part 21 of the male terminal 2, it improves the capacitance characteristics in the area where the mating part 21 of the male terminal 2 is located, that is, improving the capacitance characteristic at the area where the male and female terminals are mated and connected, thereby improving impedance matching and enhancing data transmission performance.

In addition, it is appreciated that the shielding shell 4 may serve as a mating assisting structure, when a UTP type male connector consisting of the male terminal assembly 600 is to be connected with a STP type mating female connector, the UTP male connector may provide a mating interface that is the same as or similar to a STP male connector. In other words, the UTP male connector has a mating interface being compatible with a STP mating female connector. Thus, a male connector consisting of the male terminal assembly 600 may be attached to unshielded twisted-pair cable, however a male connector to be mated with such male connector may still be a connector developed for STP application.

On the other hand, the shielding shell 4 may be simply removed when the UTP type male terminal assembly 600 is to be plugged with a mating UTP type female connector. Therefore, the UTP type male connector shown in FIGS. 1-6 may be adapted to various application scenarios, including plugging with an STP type female connector and plugging with an UTP type female connector.

The following passages further describe the connection and assembly relationship between shielding shell 4 and plastic shell 1.

Referring now to FIG. 2, the shielding shell 4 in some embodiments is provided with a latch 40, and the plastic shell 1 is provided with a latching slot 110 for the latch 40 to be engaged. In other embodiments, a latch may be formed on the plastic shell 1, and a latching slot for latch connection may be provided on the shielding shell 4.

In addition, in order to achieve rapid and precise docking between the plastic shell 1 and the shielding shell 4, referring to FIGS. 1 and 3, a guide portion 120 may be provided in one of the plastic shell 1 and the shielding shell 4, and a guide slot 41 may be provided in the other one, facilitating the guide portion 120 to slide therein. When the latch 40 is engaged with the latching slot 110, the guide portion 120 is embedded in the guide slot 41. Specifically, in the illustrated embodiment, the guide portion 120 is provided on the lower shell 12, and the guide groove 41 is provided on the shielding shell 4. It is appreciated that in other embodiments, the guide portion 120 may also be provided on the shielding shell 4, and accordingly, the guide slot 41 and be formed on the plastic shell 1.

The guide portion 120 is to cooperate with the guide slot 41 to provide positioning guidance when connecting the plastic shell 1 and the shielding shell 4 together. The guide portion 120 may also limit the relative circumferential rotation between the plastic shell 1 and the shielding shell 4, improving the stability of the docking between the plastic shell 1 and the shielding shell 4.

The following describes the interlocking mechanism between the plastic shell 1 and the male terminal 2. It should be understood that these interlocking positioning mechanisms are described as optional implementation methods, as the construction of the shielding shell 4 and its assembly relationship with the plastic shell 1 in this disclosure generally do not affect the selection of male terminals.

Referring now to FIG. 3, the plastic shell 1 in some embodiments is provided with a positioning slot 14 for partially embedding the main body 20 of the male terminal 2. The positioning slot 14 is structurally aligned with the contour of a corresponding part of the main body 20 of the male terminal 2, thereby forming a positioning effect in conjunction with the clamping member 13.

As shown in FIG. 5, the main body 20 of the male terminal 2 is also provided with a first protrusion 201, and the plastic shell 1 is provided with a first slot 15 for the first protrusion 201 to be inserted. When the upper shell 11 and the lower shell 12 are interlocked together, the first protrusion 201 is embedded into the first slot 15 to also form a limit for the male terminal 2, improving the positional stability of the installation and use of the male terminal 2.

As also shown in FIG. 5, the plastic shell 1 is provided with a second protrusion 19 facing the main body 20, and the main body 20 is provided with a second slot 202 for the second protrusion 19 to be inserted. The second protrusion 19 and the second slot 202 cooperate to further enhance the stability of the installation and fixation of the male terminal 2. It may be understood that in other embodiments, the second protrusion 19 may also be formed on the main body 20, accordingly, the second slot 202 is positioned on the first housing 1.

As shown in FIGS. 3 and 5, a clamping member 13 may be provided in the upper shell 11 to clamp the main body 20. Specifically, in some embodiments, referring to FIG. 3, the clamping member 13 includes a first clamping portion 130 and a second clamping portion 131 spaced apart, each clamping a male terminal 2. At least one of the first clamping portion 130 and the second clamping portion 131 is provided with a limiting portion 132, which extends laterally towards the male terminal 2. As shown in FIG. 5, the main body 20 of the male terminal 2 is provided with a slot 200 for inserting the limiting portion 132

The following describes the assembly features related to twisted pair 3 in the plastic shell body 1. It should be understood that these assembly features are described as optional implementation methods, as the construction of the shielding shell 4 and its assembly relationship with the plastic shell 1 in this disclosure generally do not affect the assembly features related to the twisted pair 3 in the plastic shell 1.

As shown in FIG. 2, the plastic shell 1 is provided with a first contact portion 16 and a second contact portion 17 spaced apart in the accommodating cavity 10. The first contact portion 16 and the second contact portion 17 are facing to each other and pressing against insulation sheath 31 of the twisted-pair cable 3.

The contacting ends of the first contact portion 16 and the second contact portion 17 which are to contact with the insulation sheath 31 of the twisted-pair cable 3 may adopt structures such as convex edges, barbed structure, so as to increase the relative friction between the first contact portion 16, the second contact portion 17, and the insulation sheath 31, thereby providing a holding force for the insulation sheath 31 and reducing the tensile force directly acting on the male terminal 2 when using the male terminal assembly.

As shown in FIG. 3, there is a limit slot 18 inside the plastic shell 1 for the insulation sheath 31 to be fitted. The insulation sheath 31 has an end face 310 facing the male terminal 2, and at least a part of the end face 310 is opposite to the slot wall of the limit slot 18. When the insulation sheath 31 is partially embedded in the accommodating cavity 10, the groove wall of the limiting groove 18 limits the displacement of the end face 310, thereby reducing the direct pushing effect of the insulation sheath 31 on the male terminal 2 and improving the protection of the male terminal 2.

The above embodiments are only used to help understand the technical solution and core idea of the present disclosure; Ordinary technical personnel in this field should understand that they may still modify the technical solutions described in the aforementioned embodiments, or equivalently replace some of the technical features; And these modifications or substitutions do not deviate from the essence of the corresponding technical solutions from the scope of the technical solutions of the various embodiments of the present disclosure.

1. A male terminal assembly, comprising:
a plastic shell, the plastic shell comprises a cavity to accommodate and position a pair of male terminals; and
a shielding shell disposed at a front end of the plastic shell, the male terminal assembly being configured to connect with an unshielded twisted-pair cable.

2. The male terminal assembly according to claim 1, wherein the male terminal assembly is configured for installation into a housing of an electrical connector for a twisted-pair cable and wherein the housing of electrical connector for twisted-pair cable has a terminal channel for receiving one or more terminal assembles.

3. The male terminal assembly according to claim 2, wherein the housing of the electrical connector for twisted-pair cable is a housing of electrical connector for a shielded twisted-pair (STP) cable.

4. The male terminal assembly according to claim 2, wherein the male terminal assembly is detachably mounted to the front end of the plastic shell.

5. The male terminal assembly according to claim 4, wherein the male terminal assembly is configured to be installed into a housing of electrical connector for unshielded twisted-pair (UTP) cable after the shielding shell is removed.

6. The male terminal assembly according to claim 1, wherein the male terminal assembly comprises a main body and a mating part, wherein the main body is within the plastic shell, and wherein the mating part extends beyond the front of the plastic shell.

7. The male terminal assembly according to claim 6, wherein the shielding shell circumferentially surrounds the mating part.

8. The male terminal assembly according to claim 7, wherein a rear part of the shielding shell is sleeved on the plastic shell and wherein the front part of the shielding shell extends beyond the mating part.

9. The male terminal assembly according to claim 7, wherein the plastic shell comprises an upper shell and a lower shell.

10. The male terminal assembly according to claim 1, wherein the unshielded twisted-pair cable comprises a single twisted-pair of conductors and an insulation sheath covering the single twisted-pair of conductors.

11. The male terminal assembly according to claim 10, wherein a rear part of the plastic shell comprises a cable retaining portion configured to accommodate and retain a segment of unshielded twisted-pair cable with the insulation sheath not being stripped away.

12. The male terminal assembly according to claim 1, wherein the male terminal assembly is not configured to connect with a shielded twisted-pair cable.

13. An Ethernet connector, comprising:
a collector, the collector having a terminal channel to receive terminal assembly; and
one or more male terminal assemblies according to claim 1 inserted into the terminal channel of the collector.

14. The Ethernet connector of claim 13, wherein the Ethernet connector is a modular Ethernet connector for an automotive vehicle.

15. The Ethernet connector of claim 13, wherein the Ethernet connector is configured to connect with an unshielded twisted-pair cable.
